(19) United States
(12) Patent Application Publication
(10) Pub. No.: US 2019/0213279 A1
(43) Pub. Date: Jul. 11, 2019

(54) APPARATUS AND METHOD OF ANALYZING AND IDENTIFYING SONG

(71) Applicants: ELECTRONICS AND TELECOMMUNICATIONS RESEARCH INSTITUTE, Daejeon (KR); GANGNEUNG-WONJU NATIONAL UNIVERSITY INDUSTRY ACADEMY COOPERATION GROUP, Gangneung-Si (KR)

(72) Inventors: Jung Hyun KIM, Daejeon (KR); Jee Hyun PARK, Daejeon (KR); Yong Seok SEO, Daejeon (KR); Won Young YOO, Daejeon (KR); Dong Hyuck IM, Daejeon (KR); Jin Soo SEO, Gangneung-si (KR)

(21) Appl. No.: 15/904,596

(22) Filed: Feb. 26, 2018

(30) Foreign Application Priority Data
Jan. 8, 2018 (KR) 10-2018-0002223

(51) Int. Cl. G06F 17/30

(52) U.S. Cl. CPC G06F 17/30743; G06F 17/30755

(57) ABSTRACT

An apparatus and method of analyzing and identifying a song with high performance identify a subject song in which global and local characteristics of a feature vector are reflected, and quickly identify a cover song in which changes in tempo and key are reflected by using a feature vector extracting part, a feature vector condensing part, and a feature vector comparing part, and by condensing a feature vector sequence into global and local characteristics in which a melody characteristic is reflected.

### CROSS REFERENCE TO RELATED APPLICATION

The present application claims priority to Korean Patent Application No. 10-2018-0002223, filed Jan. 8, 2018, the entire content of which is incorporated herein for all purposes by this reference.

### BACKGROUND OF THE INVENTION

### 1. Field of the Invention

The present invention relates generally to an apparatus and method of analyzing and identifying a song. More particularly, the present invention relates to an apparatus and method of analyzing and identifying a song, the apparatus and method being capable of identifying a subject song including a cover song and a remake song.

### 2. Description of Related Art

Recently, along with the growth of the digital sound source market, a large quantity of sound sources is provided to the market. In addition, various sound source contents based on original music such as live songs or remake songs of artists, cover music by ordinary persons, etc. are provided. Accordingly, development of a song searching method of searching for a specific sound source from various sound sources is drawing attention.

Such a song searching method is widely used for preventing recoding live performance of an artist or for preventing illegal acts of distributing cover song recorded without the consent of the original author. Therefore, the importance of development of a song searching method is increasing day by day.

Herein, a cover or remake song may be a song produced by modifying at least one of characteristic elements of original song. For example, in a cover or remake song, various differences such as changes in tone by differences in singers and instruments, changes in tempo or rhythm due to performance speed and performance styles, changes in chords, changed in a structure of a song, changes in lyrics, etc. may be present relative to original music.

Accordingly, in a conventional song searching apparatus, searching efficiency becomes low since the apparatus is not capable of clearly determining a changed characteristic element between an original song and a cover or remake song.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to provide an apparatus for analyzing and identifying a song in which analyzing and identifying speed is increased and reliability is improved.

Another object of the present invention to solve the above problems is to provide a method of analyzing and identifying a song in which analyzing and identifying speed is increased and reliability is improved.

In order to achieve the above object, according to an embodiment of the present invention, there is provided an apparatus for analyzing and identifying a song, wherein the apparatus operates in association with a music server including at least one candidate song, and identifies a subject song that is similar to a query song to be identified from the candidate song, the apparatus including: a feature vector extracting part respectively extracting feature vector sequences from a sound source signal of the at least one candidate song and a sound source signal of the query song; a feature vector condensing part condensing the feature vector sequence of the at least one candidate song into a first condensing feature of the candidate song and a second condensing feature of the candidate song, and condensing the feature vector sequence of the query song into a first condensing feature of the query song and a second condensing feature of the query song; and a feature vector comparing part calculating a similarity between the query song and the at least one candidate song by comparing the first condensing feature of the candidate song with the first condensing feature of the query song, and by comparing the second condensing feature of the candidate song with the second condensing feature of the query song.

Herein, the feature vector extracting part may include: a first extracting part respectively dividing the sound source signal of the query song and the sound source signal of the at least one candidate song into a frame unit; a second extracting part extracting a feature vector of the query song and a feature vector of the candidate song from the at least one frame; and a third extracting part generating the feature vector sequence of the query song by listing the feature vector of query song by chronological order, and generating the feature vector sequence of the candidate song by listing the feature vector of the candidate song by chronological order.

In addition, the second extracting part may extract the feature vector of the query song and the feature vector of the candidate song by: respectively transforming the sound source signal of the query song and the sound source signal of the at least one candidate song, the sound source signals being respectively divided into the frame units, into signals in a frequency form; respectively extracting at least one octave having at least one scale from the signals transformed into the frequency form; and respectively adding a pitch value that is an energy amount of the scale in a unit of the octave.

The feature vector condensing part may include: a global condensing part extracting the first condensing feature of the candidate song from the feature vector sequence of the at least one candidate song, and extracting the first condensing feature of the query song from the feature vector sequence of the query song; and a local condensing part extracting the second condensing feature of the candidate song from the feature vector sequence of the at least one candidate song, and extracting the second condensing feature of the query song from the feature vector sequence of the query song.

In addition, the global condensing part may include: a sampling part performing re-sampling for the feature vector sequence of the query song and for the feature vector sequence of the candidate song in at least one scale according to at least one sampling rate; and a calculating part calculating at least one first condensing feature of the candidate song from the feature vector sequence of the candidate song and calculating the first condensing feature of the query song from the feature vector sequence of the query song, the feature vector sequences being re-sampled in at least one scale.

Herein, the calculating part may include: a first calculating part dividing the feature vector sequence of the query song and the feature vector sequence of the candidate song which are re-sampled into a block by dividing the feature vector sequences into an arbitrary number of frames; and a second calculating part respectively extracting the feature vector of the candidate song and the feature vector of the query song by applying two-dimensional discrete Fourier transform to each frame divided by the first calculating part, and respectively calculating the first condensing feature of the candidate song and the first condensing feature of the query song, the condensing features having a predetermined length, by and respectively selecting median values from the feature vectors of the extracted candidate song and the feature vectors of the query song.

Herein, a size of the first condensing feature of the query song may be calculated by multiplying the arbitrary number of frames by a number of dimensions of the feature vector of the query song, and a size of the first condensing feature of the candidate song may be calculated by multiplying the arbitrary number of frames by a number of dimensions of the feature vector of the candidate song.

The global condensing part may include a second calculating part analyzing changes in tempo of the query song by adjusting a resolution of a feature vector sequence of each frame of the query song, and analyzing changes in tempo of the candidate song by adjusting a resolution of a feature vector sequence of each frame of the candidate song.

In addition, the local condensing part may include: a first local condensing part generating a subsequence of the query song by extracting tₙ-th (t and n are integers equal to or greater than 1) feature vectors from the feature vector sequence of the query song and arranging the extracted feature vectors by chronological order, and generating a subsequence of the candidate song by extracting tₙ-th (t and n are integers equal to or greater than 1) feature vectors from the feature vector sequence of the candidate song and arranging the extracted feature vectors by chronological order, and a second local condensing part calculating the second condensing feature of the query song from the subsequence of the query song, the second condensing feature of the query song having a predetermined size, and calculating the second condensing feature of the candidate song from the subsequence of the candidate song, the second condensing feature of the candidate song having a predetermined size.

Herein, the second local condensing part may include a first generating part: generating a first subsequence of the query song by respectively extracting a specific number of feature vector elements from the subsequence of the query song, and generating a second subsequence of the query song by using remaining feature vector elements of the subsequence of the query song from which the first subsequence is excluded when calculating the second condensing feature of the query song, and generating a first subsequence of the candidate song by respectively extracting a specific number of feature vector elements from the subsequence of the candidate song, and generating a second subsequence of the candidate song by using remaining feature vector elements of the subsequence of the candidate song from which the first subsequence is excluded when calculating the second condensing feature of the candidate song.

In addition, the second local condensing part may include a second generating part: calculating the second condensing feature having the predetermined size of the query song, and being configured with feature vectors in which a pairwise-distance becomes maximum by comparing a pairwise-distance between feature vectors within the first subsequence of the query song and feature vectors within the second subsequence of the query song; and calculating the second condensing feature having the predetermined size of the candidate song and being configured with feature vectors in which a pairwise-distance becomes maximum by comparing a pairwise-distance between feature vectors within the first subsequence of the candidate song and feature vectors within the second subsequence of the candidate song.

The feature vector condensing part may include a feature condensing DB including a global condensing DB and a local condensing DB, wherein the global condensing DB stores at least one first condensing feature of the candidate song, and the local condensing DB stores at least one second condensing feature of the candidate song.

The feature vector comparing part may includes: a first comparing part calculating a global distance by comparing a distance between at least one first condensing feature of the candidate song with the first condensing feature of the query song; a second comparing part calculating a local distance by comparing a distance between at least one second condensing feature of the candidate song with the second condensing feature of the query song; and a third comparing part calculating the similarity between the query song and the candidate song by multiplying the global distance by the local distance.

Herein, the first comparing part may calculate a pairwise-distance between the condensing feature of the fast query song and the first condensing feature of the candidate song which are extracted for each at least one sampling rate, and determine a minimum value among calculated pairwise-distance data as the global distance.

In addition, the second comparing part may calculate the local distance by: calculating a pairwise-distance between the second condensing feature of the query song and the second condensing feature of the candidate song calculating a third group having a minimum distance among calculated pairwise-distance data; calculating a fourth group by extracting at least one element from the third group and arranging the extracted element by chronological order, and adding the at least one calculated element.

In addition, the feature vector sequence may be a chroma feature vector sequence.

In order to achieve the above object, according to another embodiment of the present invention, there is provided a method of analyzing and identifying a song, wherein the method is performed in association with a music server including at least one candidate song, and identifies a subject song that is similar to a query song to be identified from the candidate song, the method including: respectively extracting feature vector sequences from a sound source signal of at least one candidate song and a sound source signal of the query song respectively generating first condensing features and second condensing features from the extracted feature vector sequence of the query song and the feature vector sequence of the candidate song calculating a similarity by multiplying a global distance calculated from the first condensing features by a local distance calculated from the second condensing features; and determining whether or not the at least one candidate song is the subject song based on the calculated similarity.

Herein, the respectively extracting the feature vector sequences of the query song and the at least one candidate song may include: dividing the sound source signal of the query song and the sound source signal of the at least one candidate song into at least one frame unit; respectively applying Fourier transform to the sound source signal of the query song and the sound source signal of the at least one candidate song which are divided into the frame unit; respectively extracting feature vectors from the frames of the query song and the at least one candidate song; and respectively listing the extracted feature vector of the query song and the extracted feature vector of the at least one candidate song by chronological order.

Each of the first condensing features may be generated by: dividing the feature vector sequence of the query song or the candidate song into at least one block; extracting at least one feature vector by applying 2D-DFT to a feature vector sequence within the at least one block; and extracting a median value among the extracted feature vectors.

In addition, each of the second condensing feature may be generated by: generating a first subsequence by extracting feature vectors positioned at a first interval from each feature vector sequence; generating a first group by adding at least one pairwise-distance between feature vectors of the generated first subsequence; generating a second group by adding pairwise-distances between the first subsequence and the second subsequence; and updating a feature vector element within the first group which maximizes a distance of the first group when a minimum distance of the first group is smaller than a distance of the second group.

According to an embodiment of the present invention, there is provided an apparatus and method of analyzing and identifying a song, the apparatus and method being capable of keeping characteristic of an original song in spite of changes in key the original song by extracting a feature vector having a chord characteristic by using a feature vector extracting part.

In addition, by using a global condensing part and a local condensing part within a feature vector condensing part, changes in tempo can be determined by condensing a feature vector into a predetermined length, and an analyzing and identifying speed can be increased since redundancy of information is solved.

In addition, by using a feature vector comparing part, analyzing and identifying performance can be improved since all characteristics are reflected by a global condensing part and a local condensing part.

### BRIEF DESCRIPTION OF THE DRAWINGS

The above and other objects, features, and other advantages of the present invention will be more clearly understood from the following detailed description when taken in conjunction with the accompanying drawings, in which:

FIG. 1 is a view showing a configuration diagram of a song analyzing and identifying apparatus according to an embodiment of the present invention.

FIG. 2 is a view showing a configuration diagram of a global condensing part within the song analyzing and identifying apparatus according to an embodiment of the present invention.

FIG. 3 is a view showing a configuration diagram of a local condensing part within the song analyzing and identifying apparatus according to an embodiment of the present invention.

FIG. 4 is a view showing a conceptual diagram of a subsequence of the local condensing part of the song analyzing and identifying apparatus according to an embodiment of the present invention.

FIG. 5 is a view showing a graph showing performance of the song analyzing and identifying apparatus between a size of a partial sequence according to an example of the present invention, and a size change in a first subsequence.

FIG. 6 is a view showing a configuration diagram of a feature vector comparing part within the song analyzing and identifying apparatus according to an embodiment of the present invention.

FIG. 7 is a view showing a graph showing performance comparison of the song analyzing and identifying apparatus according to changes in the first interval within a subsequence and changes in a distance adjustment coefficient according to another embodiment of the present invention.

FIG. 8 is a view showing an operational flowchart of a song analyzing and identifying method of the song analyzing and identifying apparatus according to an embodiment of the present invention.

FIG. 9 is a view showing an operational flowchart for extracting a feature vector sequence of the song analyzing and identifying method according to an embodiment of the present invention.

FIG. 10 is a view showing an operational flowchart for condensing a feature vector sequence of the song analyzing and identifying method according to an embodiment of the present invention.

FIG. 11 is a view showing a flowchart of comparing first condensing features and second condensing features of a query song and a candidate song in the song analyzing and identifying method according to an embodiment of the present invention.

### DETAILED DESCRIPTION OF THE INVENTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like elements.

Although the terms ‘first’, ‘second’, ‘A’, and/or ‘B’ may be used to describe various elements, the elements should not be limited by these terms. These terms are merely used for the purpose of distinguishing one element from another element, and, for example, a first element may be referred to as a second element, and likewise a second element may be referred to as a first element without departing from the scope of the present invention. The term ‘and/or’ shall include a combination or any one of a plurality of listed items.

When one element is referred to as being ‘connected’ or ‘coupled’ to another element, it should be understood that the former may be directly connected or coupled to the latter, or connected or coupled to the latter via an intervening element. On the contrary, when one element is referred to as being ‘directly connected’ or ‘directly coupled’ to another element, it should be understood that the former is connected to the latter without an intervening element therebetween.

Terms used herein are merely provided for illustration of specific embodiments, and are not intended to restrict the present invention. A singular form, unless otherwise indicated, includes a plural form. Herein, the term “comprise” or “have” means that there may be specified features, numerals, steps, operations, elements, parts, or combinations thereof not excluding the possibility of the presence or addition of the specified features, numerals, steps, operations, elements, parts, or combinations thereof.

Otherwise indicated herein, all the terms used herein, which include technical or scientific terms, may have the same meaning that is generally understood by a person skilled in the art. In general, the terms defined in a common dictionary should be considered to have the same meaning as the contextual meaning of the related art, and, unless clearly defined herein, should not be understood abnormally or excessively formal meaning.

Hereinafter, preferred example embodiments of the present invention will be described in detail with reference to the accompanying drawings. The same elements may have the same reference numerals to provide a better understanding of the specification, and the details of identical elements will be omitted in order to avoid redundancy. Hereinafter, preferred embodiments according to the present invention will be described in detail with reference to the accompanying drawings.

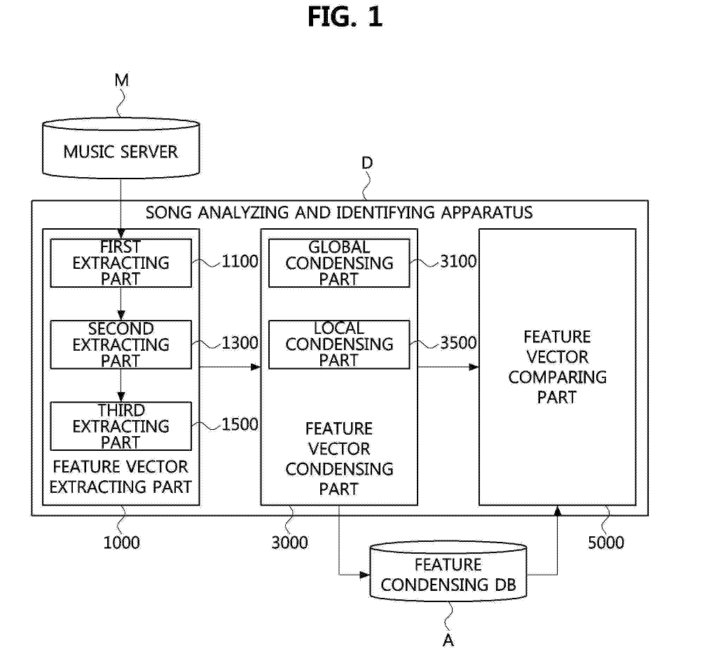

FIG. 1 is a view showing a configuration diagram of a song analyzing and identifying apparatus according to an embodiment of the present invention.

Referring to FIG. 1, a song analyzing and identifying apparatus D may be operated in association with an external music server M. Accordingly, the song analyzing and identifying apparatus D may identify a subject song that is similar to a query song among at least one candidate song stored within the music server M.

According to an embodiment, the query song may be a cover song or remake song or both of an original song, and the subject song may be an original or remake song. However, it is not limited thereto, and the query song and the subject song may be understood by interchanging embodiments thereof.

In general, a cover song or remake song or both may be produced by changing a specific element constituting an original song. Herein, the specific element may be at least one of a key, a tempo, a rhythm, and a melody.

Among them, the melody may be an element representing relative time variation of notes. In other words, the melody may be an element representing a chord configuration of the song. Accordingly, in a cover song or remake song or both, changes in melody may be less than other specific elements compared with the original song.

Herein, a feature vector may effectively represent a melody characteristic of the song. Accordingly, the song analyzing and identifying apparatus according to the present invention may extract a subject song with high reliability by respectively extracting and comparing a feature vector from a query song or at least one candidate song or both.

Described in more detail, the song analyzing and identifying apparatus may include a feature vector extracting part 1000, a feature vector condensing part 3000, and a feature vector comparing part 5000.

The feature vector extracting part 1000 may extract a feature vector sequence from a sound source signal of query song or from a feature vector sequence of at least one candidate song or from both.

The feature vector extracting part 1000 may include a first extracting part 1100 and a second extracting part 1300.

The first extracting part 1100 may divide the sound source signal of the query song or the sound source signal of the candidate song or both into at least one frame. Herein, a length of a flame section may be at least one value between from tens of ms to hundreds of ms. According to an embodiment, the frame section may be at least one value between from 20 ms to 30 ms.

The second extracting part 1300 may extract a feature vector from each divided frame of the query song or from each divided frame of the candidate song or from both.

Described in more detail, the second extracting part 1300 may respectively transform a sound source signal of the query song and a sound source signal of the candidate song which are divided into a frame unit by the first extracting part 1100 into frequency signals.

According to an embodiment, the second extracting part 1300 may transform the sound source signal of the query song that is divided into a frame unit into the frequency signal by applying Fourier transform.

According to another embodiment, the second extracting part 1300 may transform the sound source signal of the candidate song that is divided into a frame unit into the frequency signal by applying Fourier transform.

The second extracting part 1300 may extract a pitch from the frequency signal of the query song or the candidate song or both. Herein, the pitch is a number of vibrations of a tone, and may be an element determining a pitch of the tone. In other words, the pitch may represent an energy amount for each scale on the octave.

According to an embodiment, the second extracting part 1300 may extract pitches corresponding to twelve scales (C, C#, D, D#, E, F, F#, G, G#, A, A#, and B) from the frequency signal of the query song or the frequency signal of the candidate song or both.

Then, the second extracting part 1300 may extract a feature vector from the pitch extracted from the query song or the candidate song or both.

Described in more detail, the second extracting part 1300 may add an extracted pitch value in a unit of the octave. In other words, the second extracting part 1300 may add pitch values of twelve scales (C, C#, D, D#, E, F, F#, G, G#, A, A#, and B) which are present in each octave. Accordingly, the second extracting part 1300 may calculate a feature vector of twelve dimensions.

The song analyzing and identifying apparatus according to an embodiment of the present invention may calculate similarity of all songs that are represented in twelve scales by extracting a twelve-dimensional feature vector by using the second extracting part 1300.

Then, the second extracting part 1300 may normalize a size of the extracted feature vector in 1. According to an embodiment, the feature vector may be a chroma feature vector.

A third extracting part 1500 may sort at least one feature vector extracted from each frame by chronological order. Accordingly, the third extracting part 1500 may generate a feature vector sequence. According to an embodiment, the feature vector sequence may be a chroma feature vector sequence.

Accordingly, as described above, the song analyzing and identifying apparatus according to an embodiment of the present invention may provide a song analyzing and identifying apparatus with high performance in which analyzing and identifying accuracy is improved by extracting a feature vector sequence in consideration with a chord structure of the query song or the candidate song or both by using the feature vector extracting part.

The feature vector condensing part 3000 may generate a condensing feature having a predetermined size from feature vector sequences of the feature vector sequence of the query song or from feature vector sequences of at least one candidate song or from both which are extracted by the feature vector extracting part 1000.

Described in more detail, as described above, the feature vector sequence of the query song or at least one candidate song or both may be represented by sorting the feature vector extracted from at least one frame section by chronological order. In addition, the frame may be a section that is obtained by dividing the entire sound source signal of the query song or at least one candidate song or both by a predetermined section. Accordingly, the feature vector sequence extracted for each frame section may vary according to a length of the entire sound source.

In addition, the feature vector sequence may vary according to changes in key and tempo of the song. By this, analyzing and identifying efficiency may be degraded when the query song is identified by the feature vector comparing part 5000 that will be described later.

Accordingly, the feature vector condensing part of the song analyzing and identifying apparatus according to an embodiment of the present invention may remove a variability of the feature vector sequence of the query song or the feature vector sequence of at least one candidate song or both by condensing the feature vector sequence into a feature vector having a predetermined length.

By condensing the feature vector sequence into the feature vector having the predetermined length, the variability of the feature vector sequence of the query song or the feature vector sequence of at least one candidate song or both may be removed. Accordingly, a song analyzing and identifying apparatus with high performance may be provided.

As described above, the feature vector condensing part 3000 may generate a condensing feature having a predetermined size from feature vector sequences of the query song or the candidate song or both.

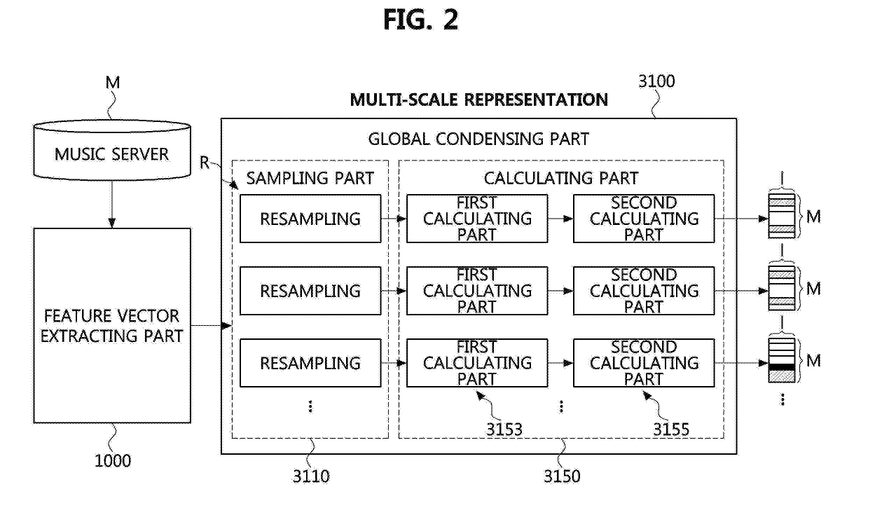

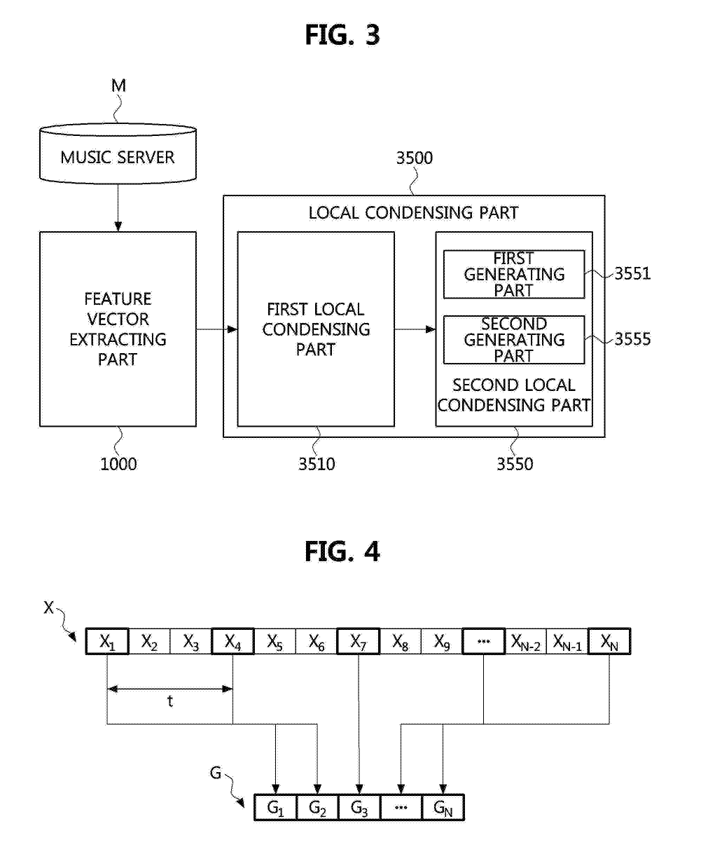

Described in more detail, the feature vector condensing part 3000 may include a global condensing part 3100, and a local condensing part 3500. The global condensing part 3100 and the local condensing part 3500 will be respectively described in detail with reference to FIGS. 2 and 3.

FIG. 2 is a block diagram of the global condensing part within the song analyzing and identifying apparatus according to an embodiment of the present invention.

Referring to FIG. 2, in order to determine changes in a structure of the entire song, the global condensing part 3100 may respectively condense the query song or at least one candidate song or both into a first condensing feature V_{A}

According to an embodiment, the global condensing part 3100 may generate a first condensing feature V_{AQ} of the query song.

According to another embodiment, the global condensing part 3100 may generate a first condensing feature V_{AA} of the candidate song.

The first condensing feature V_{AQ} of the query song V_{AQ} and the first condensing feature V_{AA} of the at least one candidate song may be respectively condensed by using the same process. Accordingly, in the following, a process of condensing the first condensing feature V_{A} will be described on behalf of the first condensing features V_{AQ} and V_{AA} of the query song and the at least one candidate song.

Described in more detail, the global condensing part 3100 may include a sampling part 3110 and a calculating part 3150.

The sampling part 3110 may perform re-sampling R for a feature vector sequence extracted by the feature vector extracting part 1000.

According to an embodiment, the sampling part 3110 may perform re-sampling R for a feature vector sequence of the query song or the feature vector sequence of the candidate song or both in various scales by using at least one sampling rate. The re-sampled feature vector sequences may be condensed into a first condensing feature V_{A} by the calculating part 3150 that will be described later.

As described above, the calculating part 3150 may condense the feature vector sequence into a first condensing feature V_{A}.

Described in more detail, the calculating part 3150 may include a first calculating part 3151, and a second calculating part 3155.

The first calculating part 3151 may divide the feature vector sequence of the query song or the candidate song or both which is re-sampled by the sampling part 3110 into a block. In other words, the first calculating part 3151 may divide the re-sampled feature vector sequence of the query song or the candidate song or both into at least one block. Herein, the block may be one segment in which the feature vector sequence is divided into a predetermined number of frames. In other words, at least one block may have a predetermined length l.

Then, the first calculating part 3151 may apply two-dimensional (2D) discrete Fourier transform (DFT) to a feature vector sequence within the block.

The second calculating part 3155 may extract a feature vector from each block to which 2D DFT is applied by the first calculating part 3151. Then, the second calculating part 3155 may extract a median value among the extracted feature vectors. Accordingly, the second calculating part 3155 may obtain a first condensing feature V_{A} having a predetermined size and from which a phase is removed for each sampling rate. In other words, the first condensing feature V_{A} may be a form of a feature vector.

According to an embodiment, the second calculating part 3155 may extract a feature vector from each block within the query song to which 2D DFT is applied by the first calculating part 3151. Then, the second calculating part 3155 may obtain a first condensing feature V_{AQ} Of the query song by extracting a median value among the extracted feature vectors.

According to another embodiment, the second calculating part 3155 may extract a feature vector from each block within at least one candidate song to which 2D DFT is applied by the first calculating part 3151. Then the second calculating part 3155 may obtain a first condensing feature V_{AA} of the candidate song by extracting a median value among extracted feature vectors.

The first condensing feature V_{A} having the predetermined size may be constant regardless of a playing time of the song. Herein, the predetermined size of the first condensing feature V_{A} may be calculated by multiplying the number l of frames within the block by a number M of dimensions of the feature vector

Accordingly, the second calculating part 3155 may determine changes in tempo of the subject song by transforming a resolution of the query song or the candidate song or both after fixing the number l of frames within the block.

The song analyzing and identifying apparatus according to an embodiment of the present invention may determine changes in a structure, in key, and in tempo of the entire song by extracting a first condensing feature by the global condensing part. In addition, a song analyzing and identifying apparatus with high performance in which various periodic information in a time axis is obtained may be provided.

FIG. 3 is a view showing a block diagram of the local condensing part within the song analyzing and identifying apparatus according to an embodiment of the present invention.

Referring to FIG. 3, the local condensing part 3500 may generate a second condensing feature V_{B} from the query song or at least one candidate song or both.

According to an embodiment, the local condensing part 3500 may generate a second condensing feature V_{BQ} of the query song.

According to another embodiment, the local condensing part 3500 may generate a second condensing feature V_{BA} of the candidate song.

The second condensing feature V_{BQ} of the query song and the second condensing feature V_{BA} of the at least one candidate song may be respectively determined by the same process. Accordingly, in the following, a process of condensing the second condensing feature V_{B} will be described on behalf of the second condensing features V_{BQ} and V_{BA} of the query song and the at least one candidate song.

Described in more detail, the local condensing part 3500 may include a first local condensing part 3510 and a second local condensing part 3550.

The first local condensing part 3510 may extract a subsequence from the feature vector sequence extracted by the feature vector extracting part 1000.

The subsequence may be generated by respectively extracting a tₙ-th feature vector from the feature vector sequence of the query song or the feature vector sequence of the at least one candidate song or both. The subsequence will be described in detail with reference to FIG. 4 that will be described later.

FIG. 4 is a view showing a conceptual diagram of the subsequence within the local condensing part of the song analyzing and identifying apparatus according to an embodiment of the present invention.

Referring to FIG. 4, as described above, a subsequence G may be extracted from a feature vector sequence X of the query song or the candidate song or both by the first local condensing part 3510. Described in more detail according to an embodiment, the subsequence G may be configured with tₙ-th positional chroma feature vectors that are sorted by chronological order. In other words, the subsequence G may be configured with chroma feature vectors positioned every first interval from an arbitrary feature vector within the chroma feature vector sequence X that is sorted by chronological order.

For example, when the chroma feature vector sequence X extracted from the feature vector extracting part 1000 is X={X₁, X₂, . . . , X_{N}}, the subsequence G may be generated by extracting an i-th vector within the chroma feature vector sequence X, by extracting at least one vector positioned spaced apart by the first interval t from the i-th vector, and by sorting the extracted vectors by chronological order. Herein, the sorted subsequence G may be represented in G={Xᵢ, Xᵢ₊ₜ, . . . , Xᵢ₊₍ₙ₋₁₎ₜ}={G₁, G₂, . . . , G_{N}}.

In other words, as described above, the subsequence G may be a sequence of chroma feature vectors sorted by chronological order and which are extracted by the feature vector extracting part 1100 from frames which are positioned spaced apart by the first interval t.

In general, correlations between feature vectors extracted from adjacent frames may be high. Accordingly, the song analyzing and identifying apparatus according to an embodiment of the present invention may provide improved discrimination by respectively extracting a subsequence from feature vector sequences of the query song or at least one candidate song or both by the first local condensing part.

However, when a value of the first interval t of the subsequence is equal to or greater than a predetermined value, a characteristic of the original song may be lost according to variations in time. Accordingly, the first interval t may be properly set so that the characteristic of the original song is not lost. According to an embodiment, the first interval t may be set to a value equal to or smaller than 3.

Properly setting the value of the first interval t will be described in more detail with an embodiment when describing a distance adjustment coefficient of the feature vector comparing part 5000 that will be described later.

Referring again to FIG. 3, the second local condensing part 3550 may generate a second condensing feature V_{B} having a predetermined size from the subsequence of the query song or the candidate song or both which are extracted by the first local condensing part 3510.

Described in more detail, the second local condensing part 3550 may include a first generating part 3551 and a second generating part 3555.

According to an embodiment, the first generating part 3551 may classify the subsequence into a first subsequence and a second subsequence. In other words, the first subsequence and the second subsequence may be minority groups respectively extracted from the feature vector sequence of the query song or the feature vector sequence of the candidate song or both.

As described above, the feature vector sequence of the query song or the feature vector sequence of the candidate song or both may be respectively extracted from at least one frame of the query song or the candidate song or both. Herein, the frame may vary according to a length of the entire sound source of the query song or the candidate song or both. Accordingly, a length of the first subsequence and a length of the second subsequence may also vary according to lengths of sound sources of the query song and candidate song. For example, when a length of a sound source of the query song the candidate song or both becomes long, numbers of feature vectors of the first subsequence and the second subsequence also increase, thus accuracy may be degraded when extracting the subject song that will be described later.

Accordingly, the first generating part 3551 may generate a first subsequence having a predetermined size by extracting k feature vectors having high discrimination from the subsequence.

In other words, the first subsequence may be a sequence chained by extracting k feature vectors from the subsequence and listing extracted k feature vectors by chronological order. According to an embodiment, the first subsequence may be represented in S={G₁, G₂, . . . , Gₖ}. For example, the size k of the first subsequence may be 32.

Performance comparison of the song analyzing and identifying apparatus according to changes in a size n of the subsequence and a size k of the first subsequence

A feature vector sequence (Full seq.) of a sound source to which sampling is not applied is extracted. Then, analyzing and identifying performance for a subject song is evaluated by adjusting a size n of a subsequence from 4 to 14, and adjusting a size k of the first subsequence from the 16 to 48 based on the feature vector sequence (Full seq.)

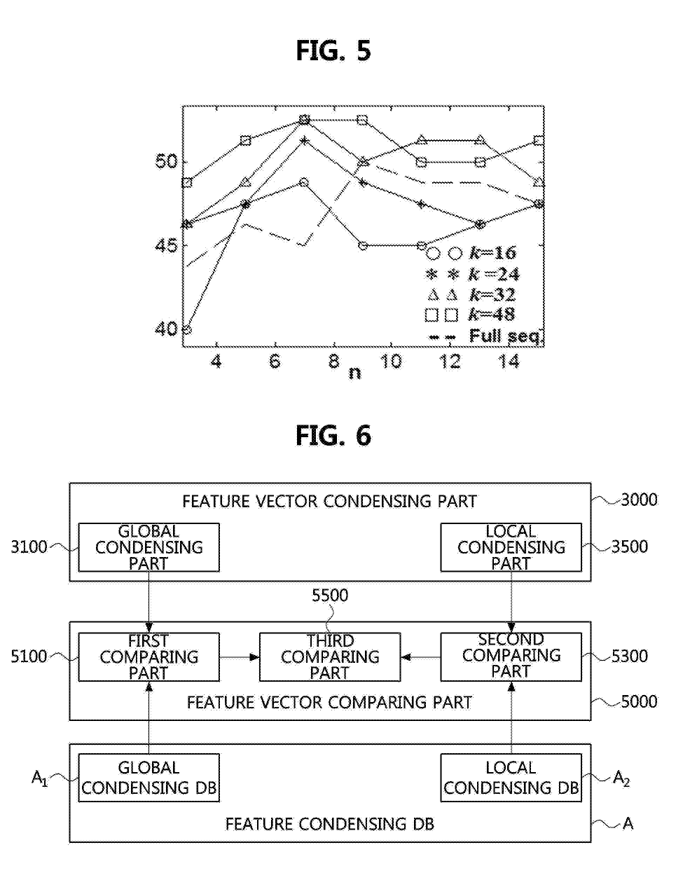

FIG. 5 is a view showing a graph showing performance comparison of a song analyzing and identifying apparatus according to changes in a size of the subsequence and a size of the first subsequence according to an embodiment of the present invention.

Referring to FIG. 5, in the song analyzing and identifying apparatus, when comparing performance between the feature vector sequence (Full seq.) to which sampling is not applied and the first subsequence to which sampling is applied (k=16 to k=48) it is confirmed that a numerical value of a similarity of the subject song is similarly calculated regardless of the size n of the subsequence.

In other words, by normalizing the feature vector sequence of the query song and the feature vector sequence of the candidate song or both in a first subsequence (k=16 to k=48), changes in the size n of the subsequence according to changes in lengths of the sound source may be prevented. Accordingly, a song analyzing and identifying apparatus with high reliability may be provided.

In addition, when the size n of the subsequence is 7, and the size k of the first subsequence is 32, it is confirmed that the similarity of the subject song is evaluated to be high. By referring this, in the song analyzing and identifying apparatus according to an embodiment of the present invention, a storage amount within the song analyzing and identifying apparatus may be adjusted by properly setting the size n of the subsequence and the size k of the first subsequence.

Referring again to FIG. 3, as described above, the first generating part 3551 may classify the second subsequence. In detail, the second subsequence may be generated by using remaining feature vectors after extracting the first subsequence and by listing the remaining feature vectors by chronological order.

For the second subsequence, a pairwise-distance with the first subsequence may be compared by the second generating part 3555 that will be described later. Comparing the pairwise-distance between the first subsequence and the second subsequence will be described in detail in the second generating part 3555 that will be described later.

As described above, the second generating part 3555 may compare the pairwise-distance between the first subsequence and the second subsequence. Accordingly, the second generating part 3555 may obtain a second condensing feature V_{B}.

In other words, the second generating part 3555 may extract a second condensing feature V_{B} having a predetermined size from the first subsequence and the second subsequence. According to an embodiment, the second condensing feature V_{B} may be calculated by using a method of maximizing a pairwise-distance.

Describing in more detail a process of calculating the second condensing feature V_{B}, the second generating part 3555 may calculate a pairwise-distance group D from the first subsequence as [Formula 1] below. In other words, the second generating part 3555 may calculate at least one pairwise-distance between feature vector elements within the fit subsequence. Herein, the calculated pairwise-distance may be a group form.

Dᵢⱼ=∥Sᵢ−Sⱼ∥ [Formula 1]

Dᵢⱼ: pairwise-distance group (1≤i,j≤k)

Sᵢ, Sⱼ: first subsequence

Then, as [Formula 2] below, the second generating part 3555 may generating a first group X by adding vector elements within the calculate pairwise-distance group Dᵢⱼ.

$$X = {\sum }_{j = 1}^{k} {D}_{ij} \qquad [ Formula 2 ]$$

X: first group

Dᵢⱼ: pairwise-distance group (1≤i≤k)

In addition, the second generating part 3555 may calculate a pairwise-distance between the first subsequence Sⱼ and a second subsequence Gₜ by referencing [Formula 3] below. Then the second generating part 3555 may calculate a second group Y by adding the calculated pairwise-distances.

$$Y = {\sum }_{j = 1}^{k} ‖ {G}_{i} - {S}_{j} ‖ \qquad [ Formula 3 ]$$

Y: second group

Sⱼ: first subsequence

Gₜ: second subsequence (t=k+1, k+2, . . . , N)

Referring to [Formula 4] below, when a minimum distance of the first group X is smaller than a minimum distance of the second group Y, the second generating part 3555 may reflect a feature vector element j within the first group X and which minimizes a distance of the first group X to the second subsequence Gₜ.

On other words, the second generating part 3555 may generate the second condensing feature V_{B} by updating at least one feature vector of the first subsequence S_{z} so that the pairwise-distance becomes a maximum value. Herein, the second condensing feature VB may be provided in a sequence form. For example, the second condensing feature VB may be represented in S={S₁, S₂, . . . , Sₖ}.

X>min(Y), [Formula 4]

S_{z}=Gₜ where z=argⱼ min dₛ[j]

X: first group

Y: second group

S_{z}: updated first subsequence

Gₜ: second subsequence

Referring again to FIG. 2, the feature vector condensing part 3000 may include a feature condensing DB A.

The feature condensing DB A may store a first condensing feature V_{AA} and a second condensing feature V_{BA} of at least one candidate song.

Described in more detail, the feature condensing DB A may include a global condensing DB and a local condensing DB.

According to an embodiment, the global condensing DB may store a first condensing feature V_{BA} of at last one candidate song.

According to another embodiment, the local condensing DB may store a second condensing feature V_{BA} of at least one candidate song.

For example, the feature vector condensing part 3000 may repeatedly extract condensing features V_{AA} and V_{BA} of at least one candidate song before extracting first and second condensing features V_{AQ} and V_{BQ} of the query song. Then, the extracted condensing features V_{AA} and V_{BA} of the plurality of candidate song may be stored in the feature condensing DB A.

Accordingly, the song analyzing and identifying apparatus D according to an embodiment of the present invention may extract and compare the first and second condensing features V_{AQ} and V_{BQ} by including the feature condensing DB storing condensing features V_{AA} and V_{BA} of plurality of candidate songs when comparing condensing features of the query song and at least one candidate song or both performed by the feature vector comparing part 5000 that will be described later. Accordingly, in the song analyzing and identifying apparatus D according to an embodiment of the present invention, a subject song similar to the query song may be quickly identified.

FIG. 6 is a block diagram of the feature vector comparing part within the song analyzing and identifying apparatus according to an embodiment of the present invention.

Referring to FIG. 6, the feature vector comparing part 5000 may select a subject song by extracting a similarity between the query song and at least one candidate song.

Described in more detail, the feature vector comparing part 5000 may include a first comparing part 5100, a second comparing part 5300, and a third comparing part 5500.

The first comparing part 5100 may compare the first condensing feature V_{AQ} of the query song with the first condensing feature V_{AA} of the candidate song. Accordingly, the first comparing part 5100 may calculate a global distance between the first condensing feature V_{AQ} of the query song and the first condensing feature V_{AA} of the candidate song.

According to an embodiment, the first comparing part 5100 may calculate a pairwise-distance between a first condensing feature V_{AQ} of the query song transmitted from the global condensing part 3100, and a first condensing feature V_{AA} of at least one candidate song transmitted from a global condensing DB A1. Then, the first comparing part 5100 may select as a global distance a minimum distance value among calculated pairwise-distance data.

In addition, the second comparing part 5300 may compare a second condensing feature V_{BQ} of the query song with a second condensing feature V_{BA} of the candidate song. Accordingly, the second comparing part 5300 may calculate a local distance between the second condensing feature V_{BQ} of the query song and the second condensing feature V_{BA} of the candidate song.

The second comparing part 5300 may calculate a pairwise-distance between a second condensing feature V_{BQ} of the query song transmitted from the local condensing part 3500, and a second condensing feature V_{BA} of the candidate song transmitted from a local condensing DB A2 by referencing [Formula 5] below.

Dᵢⱼ=∥V_{BQ}−V_{BA}∥ [Formula 5]

Dᵢⱼ: pairwise-distance (1≤i,j≤k)

V_{BQ}: second condensing feature of query song

V_{BA}: second condensing feature of candidate song

The second comparing part 5300 may calculate a third group dₘᵢₙ. The third group dₘᵢₙ may be calculated as a minimum distance between the second condensing feature V_{BQ} of the query song and the second condensing feature V_{BA} of the candidate song by referencing [Formula 6] below.

dₘᵢₙ[i]=minⱼ[Dᵢⱼ] [Formula 6]

Then, the second comparing part 5300 may calculate a fourth group dₛₒᵣₜ by sorting feature vector elements within the third group dₘᵢₙ in ascending order.

The second comparing part 5300 may calculate a local distance Dₛₑₜ between the query song and at least one candidate song by using the calculated fourth group dₛₒᵣₜ as [Formula 7] and [Formula 8] below.

$${D}_{set} ( {V}_{BQ} , {V}_{BA} ) = {\sum }_{t = 1}^{T} {d}_{sort} [ t ] \qquad [ Equation 7 ]$$

Dₛₑₜ: local distance

V_{BQ}: second condensing feature of query song

V_{BA}: second condensing feature of candidate song

T=rk [Formula 6]

r distance adjustment coefficient (0<r<1)

k: length of third group

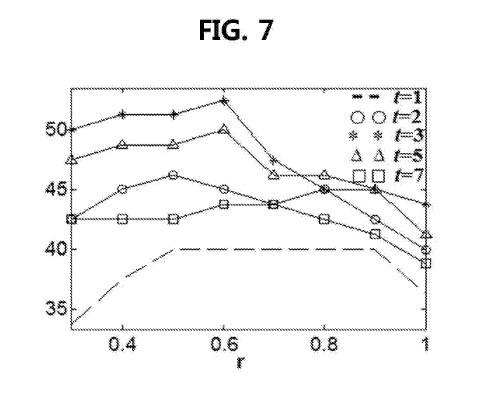

According to an embodiment, the distance adjustment coefficient r may be set to a value from 0.4 to 0.6, setting the value of the distance adjustment coefficient r will be described in detail with reference to an example of FIG. 7.

The second comparing part 5300 may determine a subject song by using a part of values of the second condensing features V_{BQ} and V_{BA}.

Accordingly, the song analyzing and identifying apparatus according to an embodiment of the present invention may quickly remove from candidate subjects at least one candidate song having been remarkably modulated from the original song or from which a part has been removed by determining the subject song using a part of the condensing features. Accordingly, the subject song may be quickly identified.

Performance Comparison of the Song Analyzing and Identifying Apparatus According to Changes in a First Interval t within the Subsequence and a Value of the Distance Adjustment Coefficient r

A sound source having a subsequence with a size n thereof being 7, and a first subsequence with a size k thereof being 32 is provided.

Then, a similarity of the sound source is evaluated by adjusting the first interval t of the subsequence and the distance adjustment coefficient r.

In more detail, the similarity of the sound source is evaluated by adjusting a setting value of the first interval t as 1, 2, 3, 5, and 7, and adjusting the distance adjustment coefficient r from 0.4 to 1.

FIG. 7 is a view showing a graph showing performance comparison of the song analyzing and identifying apparatus according to changes in the first interval t within the subsequence and in the distance adjustment coefficient r according to another embodiment of the present invention.

Referring to FIG. 7, it is confirmed that analyzing and identifying performance of a subject song using subsequences (t=2 to t=7) has been improved than that of using a specific vector sequence (t=1) to which sampling is not applied. However, when the fast interval t is equal to or greater than 3, it is confirmed that a value of a pairwise-distance has been degraded.

In other words, when the fast interval t is equal to or greater than 3, a characteristic according to variations in time of the feature vector sequence is lost, thus performance of the sound source analyzing and identifying device may be degraded.

Accordingly, the first local condensing part 3510 may set the first interval t in consideration of the above feature when setting the first interval t.

In addition, when a value equal to or greater than 0.4 and equal to or smaller than 0.6 is applied to the distance adjustment coefficient r, it is confirmed that a numerical value of a similarity in the sound source analyzing and identifying device is evaluated to be high. However, when a value equal to or smaller than 0.4 or equal to or greater than 0.6 is used as the distance adjustment coefficient r, it is confirmed that performance of the sound source analyzing and identifying device is degraded since the numerical value of the similarity is evaluated to be low. Accordingly, the distance adjustment coefficient r of the second comparing part 5300 may be set to a value from 0.4 to 0.6.

The song analyzing and identifying apparatus according to an embodiment of the present invention may provide a song analyzing and identifying apparatus with high reliability in which an internal redundancy is reduced and a characteristic according to variations in time of the feature vector sequence is maintained by properly setting values of the first interval t and the distance adjustment coefficient r.

Referring again to FIG. 6, the third comparing part 5500 may calculate a similarity between the query song and at least one candidate song. The similarity may be calculated by multiplying a global distance extracted from the first comparing part 5100 by a local distance extracted by the second comparing part 5300.

Described in more detail, as described above, a global characteristic of the feature vector sequence may be determined in the global distance extracted by the first comparing part 5100.

In addition, in the local distance extracted by the second comparing part 5300, a local characteristic of the feature vector sequence may be determined.

Accordingly, the third comparing part 5500 may determine both of the global and local characteristics of the feature vector sequence when calculating the similarity by multiplying the global distance by the local distance.

Then, the third comparing part 5500 may determine whether or not the subject song is the query song based on the calculated similarity. In other words, the third comparing part 5500 may determined whether or not the subject song is the query song based on the calculated similarity.

Hitherto, the song analyzing and identifying apparatus according to an embodiment of the present invention has been described.

The song analyzing and identifying apparatus according to embodiments of the present invention may provide a song analyzing and identifying apparatus with an increased analyzing and identifying speed, and the song analyzing and identifying apparatus according to embodiments of the present invention may provide reliability by including a feature vector extracting part, a feature vector condensing part, and a feature vector comparing part.

In addition, the song analyzing and identifying apparatus may be used as a sound source identifying system capable of identifying up to a cover song, in addition to an original song by using with a conventional fingerprint method.

Hereinafter, a song analyzing and identifying method of which uses the song analyzing and identifying apparatus will be described.

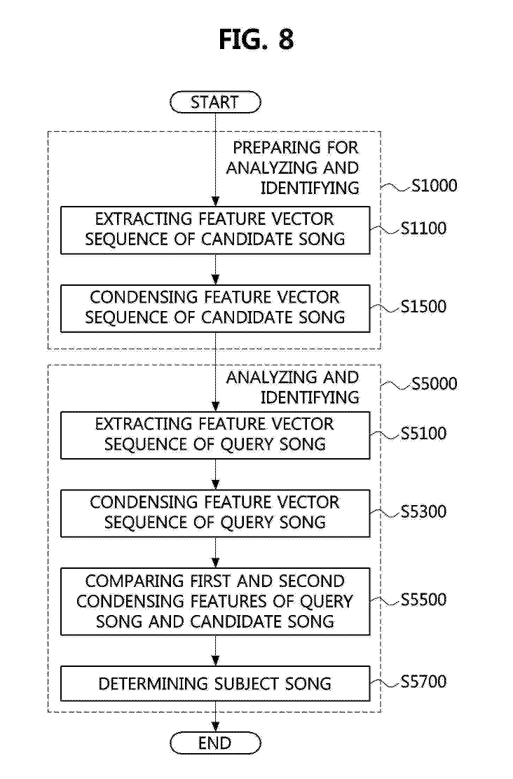

FIG. 8 is a view showing an operational flowchart of the song analyzing and identifying method according to an embodiment of the present invention.

Referring to FIG. 8, in step S1000, a preparation step for identifying a subject song may be performed. In other words, a feature condensing DB may be configured for analyzing and identifying the subject song. Herein, as described above, the feature condensing DB may be a database including at least one condensing feature of a candidate song.

The song analyzing and identifying apparatus may store feature condensing vectors of a plurality of candidate songs within the feature condensing DB by repeatedly performing the preparation step for identifying the subject song.

Described in more detail, in step S1100, the song analyzing and identifying apparatus may extract a feature vector sequence from a sound source signal of at least one candidate song stored in an external music server.

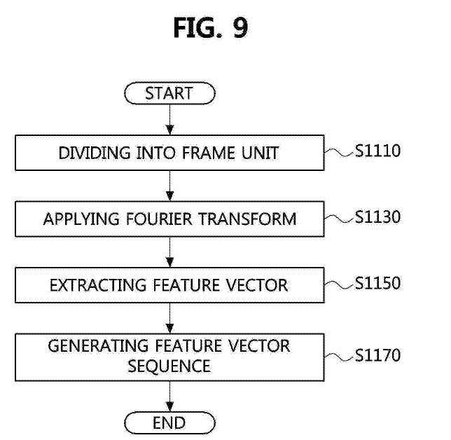

Extracting of the feature vector sequence from the sound source signal of the candidate song will be described in more detail with reference to FIG. 9.

FIG. 9 is a view showing an operational flowchart for extracting a feature vector sequence in the song analyzing and identifying method according to an embodiment of the present invention.

Referring to FIG. 9, in step S1110, the song analyzing and identifying apparatus may divide a sound source signal of at least one candidate song by least one frame unit. According to an embodiment, the sound source signal of at least one candidate song may be divided into at least one frame having a section equal to or greater than 20 ms and equal to or smaller than 30 ms.

In step S1130, Fourier transform may be applied to the sound source signal that is divided into the frame unit. In other words, the sound source signal that is divided into the frame unit may be transformed into a signal in a frequency form.

Then, in step S1150, the song analyzing and identifying apparatus may extract at least one feature vector by extracting a pitch value from at least one frame.

The song analyzing and identifying apparatus may list the extracted at least one feature vector by chronological order. Accordingly, in the S1170, a feature vector sequence of at least one candidate song may be formed.

Referring again to FIG. 8, in step S1500, the song analyzing and identifying apparatus may condense the extracted feature vector sequence of the at least one candidate song.

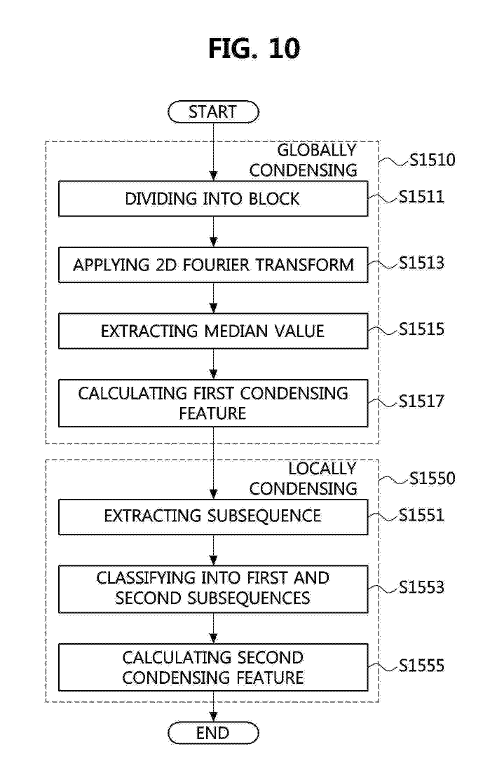

Hereinafter, with reference to FIG. 10, a method of condensing a feature vector sequence of at least one candidate song will be described in detail.

FIG. 10 is an operational flowchart for condensing a feature vector sequence in the song analyzing and identifying method according to an embodiment of the present invention.

Referring to FIG. 10, as described above, the song analyzing and identifying apparatus may condense the extracted feature vector sequence.

According to an embodiment, in step S1510, the song analyzing and identifying apparatus may globally condense the extracted feature vector sequence of the at least one candidate song.

Described in more detail, the song analyzing and identifying apparatus may perform re-sampling for the extracted feature vector sequence of the at least one candidate song in at least one sampling rate by using the global condensing part. Accordingly, in step S1511, the feature vector sequence of the candidate song may be divided into a block.

Then, in step S1513, the song analyzing and identifying apparatus may apply 2D DFT to at least one block within the feature vector sequence.

A feature vector may be extracted from each block to which 2D DFT is applied. Then, in step S1515, a median value may be extracted among the extracted feature vectors.

Accordingly, in step S1517, the song analyzing and identifying apparatus may calculate a first condensing feature V_{AA} from the feature vector sequence of at least one candidate song.

According to another embodiment, in step S1550, the song analyzing and identifying apparatus may locally condense the extracted feature vector sequence of the at least one candidate song.

Described in more detail, in step S1551, the song analyzing and identifying apparatus may generate a subsequence by extracting at least one feature vector from the extracted feature vector sequence of the candidate song by using the local condensing part.

Herein, the subsequence may be a sequence obtained by primarily extracting at least one feature vector from the feature vector sequence which is spaced apart by a predetermined interval t. In other words, the subsequence may be a group of at least one feature vector extracted from each frame spaced apart by at interval from an i-th frame of the feature vector sequence.

Then, in step S1553, the subsequence may be classified into a first subsequence and a second subsequence. Herein, the first subsequence may be a sequence obtained by secondarily extracting k feature vectors with high discrimination from the subsequence. In addition, the second subsequence may be remaining feature vectors of the subsequence, except for the first subsequence, and are listed by chronological order.

A pairwise-distance between the extracted first subsequence and second subsequence may be compared. Then, in step S1555, a second condensing feature V_{BA} may be calculated by re-extracting at least one feature vector positioned farthest away. In other words, the feature vector sequence of at least one candidate song may be condensed into a second condensing feature V_{BA}.

A process of globally condensing and locally condensing within the song analyzing and identifying method according to an embodiment of the present invention is not limited to steps described above, the process may be performed in reverse order or at the same time.

Referring again to FIG. 8, in step S5000, the song analyzing and identifying apparatus may identify a subject song.

Described in more detail, in step S5100, the song analyzing and identifying apparatus may extract a feature vector sequence of a query song that is a subject to be identified. Extracting the feature vector sequence of the query song may be performed by using the same method of extracting the feature vector sequence of the candidate song which is described with reference to FIG. 9.

In step S5300, the song analyzing and identifying apparatus may condense the extracted feature vector sequence of the query song. Condensing the feature vector sequence of the query song may be also performed by using the same method of condensing the feature vector sequence of the candidate song which is described with reference to FIG. 10.

Then, in step S5500, the song analyzing and identifying apparatus may compare a first condensing feature V_{A} and a second condensing feature V_{B} which are extracted from the query song and at least one candidate song.

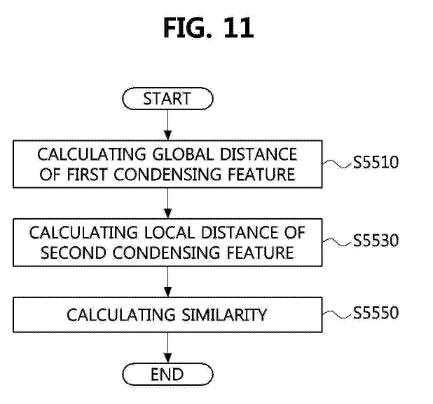

Comparing the first condensing feature V_{A} and the second condensing feature V_{B} of the query song and the candidate song will be described in detail with reference to FIG. 11.

FIG. 11 is a view showing a flowchart of comparing first condensing features and second condensing features of the query song and the candidate song in the song analyzing and identifying method according to an embodiment of the present invention.

Referring to FIG. 11, in step S5510, the song analyzing and identifying apparatus may calculate a global distance of a first condensing feature V_{AA} the query song or at least one candidate song or both. Described in more detail, pairwise-distances between the first condensing feature V_{AQ} of the query song and first condensing features V_{AA} of the candidate song which are extracted for each sampling rate in the song analyzing and identifying apparatus may be calculated. Then, the smallest distance among the calculated pairwise-distance data may be applied as the global distance.

Then, in step S5530, the song analyzing and identifying apparatus may calculate a local distance. A method of calculating the local distance has been described with reference to [Formula 5] to [Formula 8], thus a description thereof will be omitted.

A process of calculating the global distance and the local distance within the song analyzing and identifying method according to an embodiment of the present invention is not limited to steps described above, and the process may be performed in reverse order or at the same time.

Then, in step S5550, a similarity may be calculated by multiplying the calculated global distance by the local distance.

Referring again to FIG. 8, in step S5700, the song analyzing and identifying apparatus may determine at least one candidate song with high similarity as the subject song.

Then, the song analyzing and identifying apparatus repeatedly performs the method from the step S5500 by newly extracting at least one candidate song from the feature condensing DB, and by comparing a first condensing feature V_{AQ} and a second condensing feature V_{BQ} of a query song, with a first condensing feature V_{AA} and a second condensing feature V_{BA} of the candidate song. Accordingly, the song analyzing and identifying apparatus may dynamically extract a plurality of subject songs.

Hitherto, an apparatus and method of analyzing and identifying a song according to an embodiment of the present invention has been described. The song analyzing and identifying apparatus and method may provide a song analyzing and identifying apparatus and method with high performance, the method and apparatus capable of identifying a subject song in which global and local characteristics of a feature vector are reflected, and quickly identifying a cover song in which changes in tempo and key are reflected by using a feature vector extracting part, a feature vector condensing part, and a feature vector comparing part, and by condensing a feature vector sequence into global and local characteristics in which a melody characteristic is reflected.

The present invention may be implemented as computer-readable code on a computer-readable recording medium. The computer-readable recording medium includes all types of storage devices in which computer system-readable data is stored. In addition, the computer readable recording medium may be provided in a distributed processing system where computer systems are networked to store and execute the computer readable codes at distributed locations.

In addition, the example of the computer-readable recording medium may include a hardware device which is specially configured to store and execute the program command such as a ROM, a RAM, a flash memory, etc. The program may include a machine language code programmed using a complier and a high level language code which may be executed by a computer by using an interpreter. Some or all of the method steps may be executed by (or using) a hardware apparatus, like for example, a microprocessor, a programmable computer or an electronic circuit. In some embodiments, some one or more of the most important method steps may be executed by such an apparatus.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for analyzing and identifying a song, wherein the apparatus operates in association with a music server including at least one candidate song, and identifies a subject song that is similar to a query song to be identified from the candidate song, the apparatus comprising:
a feature vector extracting part respectively extracting feature vector sequences from a sound source signal of the at least one candidate song and a sound source signal of the query song;
a feature vector condensing part condensing the feature vector sequence of the at least one candidate song into a first condensing feature of the candidate song and a second condensing feature of the candidate song, and condensing the feature vector sequence of the query song into a first condensing feature of the query song and a second condensing feature of the query song; and
a feature vector comparing part calculating a similarity between the query song and the at least one candidate song by comparing the first condensing feature of the candidate song with the first condensing feature of the query song, and by comparing the second condensing feature of the candidate song with the second condensing feature of the query song.

2. The apparatus of claim 1, wherein the feature vector extracting part includes:
a first extracting part respectively dividing the sound source signal of the query song and the sound source signal of the at least one candidate song into a frame unit;
a second extracting part extracting a feature vector of the query song and a feature vector of the candidate song from the at least one frame; and
a third extracting part generating the feature vector sequence of the query song by listing the feature vector of query song by chronological order, and generating the feature vector sequence of the candidate song by listing the feature vector of the candidate song by chronological order.

3. The apparatus of claim 2, wherein the second extracting part extracts the feature vector of the query song and the feature vector of the candidate song by:
respectively transforming the sound source signal of the query song and the sound source signal of the at least one candidate song, the sound source signals being respectively divided into the frame units, into signals in a frequency form;
respectively extracting at least one octave having at least one scale from the signals transformed into the frequency form; and
respectively adding a pitch value that is an energy amount of the scale in a unit of the octave.

4. The apparatus of claim 1, wherein the feature vector condensing part includes:
a global condensing part extracting the first condensing feature of the candidate song from the feature vector sequence of the at least one candidate song, and extracting the first condensing feature of the query song from the feature vector sequence of the query song; and
a local condensing part extracting the second condensing feature of the candidate song from the feature vector sequence of the at least one candidate song and extracting the second condensing feature of the query song from the feature vector sequence of the query song.

5. The apparatus of claim 4, wherein the global condensing part includes:
a sampling part performing re-sampling for the feature vector sequence of the query song and for the feature vector sequence of the candidate song in at least one scale according to at least one sampling rate; and
a calculating part calculating at least one first condensing feature of the candidate song from the feature vector sequence of the candidate song, and calculating the first condensing feature of the query song from the feature vector sequence of the query song, the feature vector sequences being re-sampled in at least one scale.

6. The apparatus of claim 5, wherein the calculating part includes:
a first calculating part dividing the feature vector sequence of the query song and the feature vector sequence of the candidate song which are re-sampled into a block by dividing the feature vector sequences into an arbitrary number of frames; and
a second calculating part respectively extracting the feature vector of the candidate song and the feature vector of the query song by applying two-dimensional discrete Fourier transform to each frame divided by the first calculating part, and respectively calculating the first condensing feature of the candidate song and the first condensing feature of the query song, the condensing features having a predetermined length, by and respectively selecting median values from the feature vectors of the extracted candidate song and the feature vectors of the query song.

7. The apparatus of claim 6, wherein a size of the first condensing feature of the query song is calculated by multiplying the arbitrary number of frames by a number of dimensions of the feature vector of the query song, and a size of the first condensing feature of the candidate song is calculated by multiplying the arbitrary number of flames by a number of dimensions of the feature vector of the candidate song.

8. The apparatus of claim 7, wherein the global condensing part includes a second calculating part analyzing changes in tempo of the query song by adjusting a resolution of a feature vector sequence of each frame of the query song, and analyzing changes in tempo of the candidate song by adjusting a resolution of a feature vector sequence of each frame of the candidate song.

9. The apparatus of claim 4, wherein the local condensing part includes:
a first local condensing part generating a subsequence of the query song by extracting tₙ-th (t and n are integers equal to or greater than 1) feature vectors from the feature vector sequence of the query song and arranging the extracted feature vectors by chronological order, and generating a subsequence of the candidate song by extracting tₙ-th (t and n are integers equal to or greater than 1) feature vectors from the feature vector sequence of the candidate song and arranging the extracted feature vectors by chronological order; and
a second local condensing part calculating the second condensing feature of the query song from the subsequence of the query song, the second condensing feature of the query song having a predetermined size, and calculating the second condensing feature of the candidate song from the subsequence of the candidate song, the second condensing feature of the candidate song having a predetermined size.

10. The apparatus of claim 9, wherein the second local condensing part includes a first generating part:
generating a first subsequence of the query song by respectively extracting a specific number of feature vector elements from the subsequence of the query song, and generating a second subsequence of the query song by using remaining feature vector elements of the subsequence of the query song from which the first subsequence is excluded when calculating the second condensing feature of the query song, and
generating a first subsequence of the candidate song by respectively extracting a specific number of feature vector elements from the subsequence of the candidate song, and generating a second subsequence of the candidate song by using remaining feature vector elements of the subsequence of the candidate song from which the first subsequence is excluded when calculating the second condensing feature of the candidate song.

11. The apparatus of claim 10, wherein the second local condensing part includes a second generating part:
calculating the second condensing feature having the predetermined size of the query song, and being configured with feature vectors in which a pairwise-distance becomes maximum by comparing a pairwise-distance between feature vectors within the first subsequence of the query song and feature vectors within the second subsequence of the query song; and
calculating the second condensing feature having the predetermined size of the candidate song and being configured with feature vectors in which a pairwise-distance becomes maximum by comparing a pairwise-distance between feature vectors within the first subsequence of the candidate song and feature vectors within the second subsequence of the candidate song.

12. The apparatus of claim 1, wherein the feature vector condensing part includes a feature condensing DB including a global condensing DB and a local condensing DB, wherein the global condensing DB stores at least one first condensing feature of the candidate song, and the local condensing DB stores at least one second condensing feature of the candidate song.

13. The apparatus of claim 1, wherein the feature vector comparing part includes:
a first comparing part calculating a global distance by comparing a distance between at least one first condensing feature of the candidate song with the first condensing feature of the query song;
a second comparing part calculating a local distance by comparing a distance between at least one second condensing feature of the candidate song with the second condensing feature of the query song; and
a third comparing part calculating the similarity between the query song and the candidate song by multiplying the global distance by the local distance.

14. The apparatus of claim 13, wherein the first comparing part calculates a pairwise-distance between the condensing feature of the first query song and the first condensing feature of the candidate song which are extracted for each at least one sampling rate, and determines a minimum value among calculated pairwise-distance data as the global distance.

15. The apparatus of claim 13, wherein the second comparing part calculates the local distance by: calculating a pairwise-distance between the second condensing feature of the query song and the second condensing feature of the candidate song; calculating a third group having a minimum distance among calculated pairwise-distance data; calculating a fourth group by extracting at least one element from the third group and arranging the extracted element by chronological order; and adding the at least one calculated element.

16. The apparatus of claim 1, wherein the feature vector sequence is a chroma feature vector sequence.

17. A method of analyzing and identifying a song, wherein the method is performed in association with a music server including at least one candidate song, and identifies a subject song that is similar to a query song to be identified from the candidate song, the method comprising:
respectively extracting feature vector sequences from a sound source signal of at least one candidate song and a sound source signal of the query song,
respectively generating first condensing features and second condensing features from the extracted feature vector sequence of the query song and the feature vector sequence of the candidate song;
calculating a similarity by multiplying a global distance calculated from the first condensing features by a local distance calculated from the second condensing features; and
determining whether or not the at least one candidate song is the subject song based on the calculated similarity.

18. The method of claim 17, wherein the respectively extracting the feature vector sequences of the query song and the at least one candidate song includes:
dividing the sound source signal of the query song and the sound source signal of the at least one candidate song into at least one frame unit;
respectively applying Fourier transform to the sound source signal of the query song and the sound source signal of the at least one candidate song which are divided into the frame unit;
respectively extracting feature vectors from the frames of the query song and the at least one candidate song; and
respectively listing the extracted feature vector of the query song and the extracted feature vector of the at least one candidate song by chronological order.

19. The method of claim 17, wherein each of the first condensing features is generated by: dividing the feature vector sequence of the query song or the candidate song into at least one block; extracting at least one feature vector by applying 2D-DFT to a feature vector sequence within the at least one block; and extracting a median value among the extracted feature vectors.

20. The method of claim 17, wherein each of the second condensing feature is generated by:
generating a first subsequence by extracting feature vectors positioned at a first interval from each feature vector sequence; generating a first group by adding at least one pairwise-distance between feature vectors of the generated first subsequence;
generating a second group by adding pairwise-distances between the first subsequence and the second subsequence; and
updating a feature vector element within the first group which maximizes a distance of the first group when a minimum distance of the first group is smaller than a distance of the second group.
